(19) United States
(12) Patent Application Publication
(10) Pub. No.: US 2010/0264362 A1
(43) Pub. Date: Oct. 21, 2010

(54) Method of producing trichlorosilane (TCS) rich Chlorosilane product stably from a fluidized gas phase reactor (FBR) and the structure of the reactor

(76) Inventors: YongChae Chee, Beverly Hills, CA (US); Tetsunori Kunimune, La Canada, CA (US)

Correspondence Address: Yong Chae Chee, 3099 N. Lima St., Burbank, CA, 91504, US

(21) Appl. No.: 12/802,320

(22) Filed: Jun. 4, 2010

Related U.S. Application Data
(63) Continuation-in-part of application No. 12/456,979, filed on Jun. 25, 2009, now abandoned.
(60) Provisional application No. 61/133,688, filed on Jul. 1, 2008.

(51) Int. Cl. H01M 4/88

(52) U.S. Cl. 252/182.1

(57) ABSTRACT

A fluidized bed reactor (FBR) for producing chlorosilane mixture, which has high contents of tri-chlorosilane (TCS), by hydro chlorination of metallurgical silicon (MGSI) and a method of producing high contents of TCS stably with the FBR is disclosed. A cooling jacket, which surrounds the lower reactor section, combined with inert initial charging material, which does not react with HCl during the reaction at a temperature of above 300° C. and pressure of above 5 bar, controls the extreme exothermal heat of the reaction. In addition to this, combination of an optimized gas distributor and a feeder that can feed the metallurgical silicon with accuracy of ±5% enabled to realize uniform temperature profile within the reaction zone within ±1 degree ° C. deviation at 350° C. of average reaction temperature and at 5 bar of reaction pressure.

This is Continuation in Part of the U.S. patent application Ser. No. 12/456,979, which is now abandoned and which was non-provisional application of the Provisional Application No. 61/133,688 which was filed on Jul. 1, 2008.

### FIELD OF THE INVENTION

Current application relates to a FBR, especially to a FBR structure for producing TCS rich Chloro-silane mixture from direct hydro chlorination of metallurgical silicon and the method of stably producing TCS rich chlorosilane mixture.

### BACKGROUND OF THE INVENTION

Since the steep increase of the crude oil price, solar energy technology has been paid attention for the advantage of scale up to large power plant as far as the Sun lights. However, the raw material for solar cell is in short because of limited number of plants that produce the raw material, the polysilicon. In later 1970's, Union Carbide researched possibility of producing “low cost silicon solar array” under contract with NASA. They used fluidized bed to produce mixed silane of STC (Silicon Tetra Chloride), TCS, DSC (Di-Chloro-Silane), and Silane (SiH₄) from Metallurgical Silicon. However, no continuous operation is disclosed. Other results up to now failed to achieve stable continuous operation method of a FBR to produce high level of TCS concentration from hydro chlorination of metallurgical silicon. It is purpose of the current invention to provide a technology that enables continuous production of high level TCS concentration gas stably using metallurgical grade silicon dispersed in an inert solid material in a fluidized bed reactor.

### DESCRIPTION OF THE PRIOR ART

U.S. Pat. No. 2,943,918 to G. Pauls illustrates a process for manufacturing dense, extra pure silicon. That process contains a chlorosilane producing unit; major product is trichlorosilane (TCS), from metallurgical grade silicon. The TCS manufacturing unit is made of a steel pipe 1. The pipe 1 has a grid 2 that support the charge of silicon-copper alloy (these material is call as metallurgical silicon). Dry HCl is introduced from the bottom of the pipe 1 and pass through the silicon-copper alloy bed and leave the pipe at the top exit 7. The system was heated up to 240° C. and maintained using proper means. It produced TCS rich chlorosilane product. The silicon-copper alloy was charged once and no make up was done. It might be in fluidized bed mode but not in continuous steady state. They described in lines 60 to 67 of column 1 that the reaction between the silicon and HCl is very exothermic and they had to decrease the HCl flow rate to maintain the reaction temperature at desired range and so it limits the production rate of TCS.

U.S. Pat. No. 3,148,035 to Enk, et al. illustrates an apparatus for the continuous production of silicon chloroform (trichlorosilane; TCS) and/or silicon tetra-chloride (STC). The apparatus is characterized by a conical insert in the fluidized bed just above the distribution plate. The conical insert act two functions. First is to provide a cooling surface and the second is to provide a channel to discharge un-reacted solid particles. They claim that continuous removal of the un-reacted particles enabled a continuous operation. But, no information for feeding method and no information how to distinguish the fresh particle and un-reacted particle to remove from the reactor. It clearly indicates low efficiency of silicon particle use. Or the discharged material through the over outlet 12 should be recycled to the feeding conduit 8.

U.S. Pat. No. 3,704,104 to Bawa, et al. illustrates a process for the production of trichlorosilane. They claim that recycling ethylenedichloride (EDC) to their FBR increased the yield of TCS. But, their FBR structure was not disclosed and no data was disclosed.

U.S. Pat. No. 4,044,109 to Kotzsch, et al illustrates a process for preparing silicon tetrachloride or silicon trichloride wherein elemental silicon is contacted with hydrogen chloride in a fluidized bed, in the presence of an iron compound. The reactor was made of an 800 mm high cylindrical quartz tube was used, having a diameter of 50 mm. The blast tray was horizontal and had a centrally disposed gas admission aperture of approximately 3 mm diameter. To compensate for lost heat and for temperature control it was provided with a removable, electrical, controlled jacket heater (3 zones of 1 kW each). The reactor did not contain a separate cooling system. Temperature measurement was performed by three temperature sensors disposed at various levels in the fluid bed. The iron content is 10 to 43 weight percent based on the weight of the total solids in the fluidized bed, at a temperature in the range of 260-600° C., in the absence of an inert gas. The iron compound was continuously fed into the reactor as raw material. If the iron concentration used in the reactor is exceeded due to enrichment caused by the continuous feeding, sufficient waste can in some cases be let out of the fluid bed from time to time to enable the iron concentration to be kept at a constant level. Hydrogen chloride was introduced to the bed from the bottom at a gas velocity of 3.2 cm/sec with respect to the empty reactor. Based on the disclosure, it is easily found that the reactor was operated at ‘extended bed’ condition, which is more close to a ‘fixed bed’ rather than a ‘fluidized bed.’ Actually, that operation condition is not the condition that maximizes the heat transfer and mixing of the bed material. Moreover, the reactor and bed geometry is not proper for mass production of TCS.

U.S. Pat. No. 4,213,937 to Padovani, et al. illustrates a commercial scale plant design for producing granular polysilicon from TCS/STC mixture that is produced in a FBR from reacting silicon with HCl. They disclose the FBR design, which have expanded upper head section and inner cooler that reaches down to the fluidizing bed. They operated the FBR at 500 to 750 F and 8 to 10 psig. Solid impurities are removed by solid dump line at the bottom of the reactor. However, they did not disclose the feeder in detail. Moreover, they did not disclose what the bed level inside of the FBR is. Especially, when the internal cooling coil is inserted to the moving bed, it creates many problems, such as slugging and erosion of the cooling coil itself by the silicon granules and finally collapses down of the internal coil.

U.S. Pat. No. 4,585,643 to Barker, Jr illustrates a Process for preparing chloro-silanes from silicon and hydrogen chloride using an oxygen promoter. The inventor used a laboratory scale glass fluidized bed reactor (FBR). The ratio of bed height/diameter of the FBR was maintained as 10˜11/1. Silicon was made up to maintain the bed level. Though this result is limited to a laboratory scale FBR, the bed level itself causes slugging, which is very bad for heat transfer from the bed to the reactor wall. In many cases slugging confuses the operator to find out what is the real steady state.

U.S. Pat. No. 5,776,416 to Oda illustrates a FBR for producing TCS rich products from hydrogenation of silicon-tetrachloride (STC). The FBR is equipped with internal cyclone and has expanded free board upper zone. Oda illustrates dimension of the bench scale reactor. However, he made mistake that the internal cyclone is proven as not only non-functional but creates many additional problems by the FBR industry. Moreover, he misunderstood the function of the expanded zone. Based on the decades of FBR operational experience of the applicant of the current application, that reactor will not perform smoothly. The internal cyclone itself disturbs continuous operation of the FBR at that high temperature.

United States Patent Application 20090108100 by Inaba; Chikara illustrates a hydrogen chloride gas ejecting nozzle, reaction apparatus for producing trichlorosilane and method for producing trichlorosilane. The HCl gas ejecting nozzle is provided with a shaft portion extending in the longitudinal direction and a head portion that is provided on an end of the shaft portion and extends in a direction intersecting the longitudinal direction of the shaft portion. A supply hole extending in the longitudinal direction is formed in the shaft portion, a plurality of ejection holes are formed in the head portion, and each of the ejection holes is communicatively connected to the supply hole and opened on the outer surface of the head portion toward a direction intersecting the direction to which the supply hole extends. However, that kind of ‘modified bubble cap’ is proven as not effective for many gas-solid exothermic reaction system. It is easily plugged by fine particles and sticky organo-silane compounds. Once one of the ‘ejecting nozzle’ is plugged, ‘channeling’ starts and ‘hot spots’ are developed inside of the bed. This results in low content of TCS in the product stream.

U.S. Patent Application Publication 20090123359 and 20090104104 issued by Inaba; Chikara illustrates a reaction apparatus for producing trichlorosilane and method for producing trichlorosilane. The reaction apparatus is Fluidized Bed Reactor with an ejection port for ejecting the hydrogen chloride gas into the apparatus body from the bottom part of the apparatus body, wherein a plurality of holed pieces having a through hole penetrating in the thickness direction and a plurality of pellets interposed between these holed pieces are stacked in a mixed state on the upper side of the ejection port. The reason for putting some pellets on the bottom of the bed is to avoid ‘hot spot’ near the gas distribution plate. Which results in damage of the gas distributor plate? However, the pellets will just disturb moving of silicon granules and will create another ‘stagnant zone’ and another hot spot.

United States Patents Application 20100034721 and 20100034722 issued by Ishii; Toshiyuki; et al. illustrates a method and apparatus for TCS production. The apparatus includes a center tube which is inserted in the reaction chamber along a longitudinal direction of the reaction chamber and has a lower-end opening portion. The apparatus further includes a fin that leads the polymer and the hydrogen chloride to the lower-end opening portion of the center tube so as to stir the silicon and the hydrogen chloride. Major concern is how the fins can be rotated inside of such corrosive reaction environment.

All the prior arts do not disclose optimized FBR structure and operational method for producing high concentration of TCS from silicon and HCl stably. It is the purpose of the current application to provide an industrially practical FBR to produce TCS stably in terms of commercial operation.

It is another purpose of the current application to provide a method of producing TCS stably with the FBR disclosed.

Many preliminary works have been done to find the optimized structure of the FBR and the method of operation of the FBR.

Since the steep increase of the crude oil price, solar energy technology has been paid attention for the advantage of scale up to large power plant as far as the Sun lights. However, the raw material for solar cell is in short because of limited number of plants that produce the raw material, the polysilicon. In later 1970's, Union Carbide researched possibility of producing “low cost silicon solar array” under contract with NASA. They used fluidized bed to produce mixed silane of STC (Silicon Tetra Chloride), TCS, DSC (Di-Chloro-Silane), and Silane (SiH₄) from Metallurgical Silicon. However, no continuous operation is disclosed. Other results up to now failed to achieve stable continuous operation method of a FBR to produce high level of TCS concentration from hydro chlorination of metallurgical silicon. It is purpose of the current invention to provide a technology that enables continuous production of high level TCS concentration gas stably using metallurgical grade silicon dispersed in an inert solid material in a fluidized bed reactor. A fluidized bed reactor (FBR) for producing chlorosilane mixture, which has high contents of tri-chlorosilane (TCS), by hydro chlorination of metallurgical silicon (MGSI) and a method of producing high contents of TCS stably with the FBR is disclosed. A cooling jacket, which surrounds the lower reactor section, combined with inert initial charging material, which does not react with HCl during the reaction at a temperature of above 300° C. and pressure of above 5 bar, controls the extreme exothermal heat of the reaction. In addition to this, combination of an optimized gas distributor and a feeder that can feed the metallurgical silicon with accuracy of ±5% enabled to realize uniform temperature profile within the reaction zone within ±1 degree ° C. deviation at 350° C. of average reaction temperature and at 5 bar of reaction pressure.

### BRIEF DESCRIPTION OF THE DRAWINGS

FIG. 1 is a perspective view of a cold fluidized bed to optimize the ‘Operating Bed Height’ of the solid materials.

FIG. 2 is an elevated view of a gas distributor used in the cold fluidized bed according to current application.

FIG. 3 is a side cross sectional view of the fluidized bed reactor for stable production of trichlorosilane by hydrochlorination of metallurgical silicon according to current application.

FIG. 4 is a prior art that shows the cross-sectional view of gas distribution plate.

FIG. 5 is a cross sectional view of the new gas distributor designed according to current invention.

FIG. 6 is the temperature profile inside of the fluidized bed as the hydro-chlorination proceeds.

FIG. 7 is the temperature profile of the TE-7, the thermocouple reading from the middle of the bed height and jacket oil temperature from the start up.

FIG. 8 is the overall temperature readings in different part of the FBR while the reaction temperature was in control.

FIG. 9 is a detailed temperature readings in different part of the FBR while the reaction temperature was in control.

FIG. 10 is the temperature deviation within the reacting fluidized bed in both case of the hydro chlorination with—and without—the initially charging material.

### DETAILED DESCRIPTION OF THE PREFERRED EMBODIMENT OF THE INVENTION

As known to public, Fluidized Bed Reactor (FBR) is selected for extremely exothermic reaction due to their excellent mixing and heat removal capacity from the internal ‘bed’ of fluidized materials.

Among the various stage of the FBR, ‘slugging bed’ is known as ‘must be avoided’ situation unless ‘pneumatic conveying’ or ‘recycling bed’ is planned because of their unstable bed behavior and many ‘entrainment of bed material’ to the exit gas stream (Fluidization Engineering, John Wiley &Sons, Inc., pp 1˜3, Daizo Kuni and Octave Levenspiel).

When ‘slugging’ happens, upper part of the gas-solid bed is pushed up-ward and separated from the main bed. Therefore, when the ‘bed’ is operated as ‘slugging mode’, the heat transfer between the bed, where reaction occurs, and reactor wall surface drastically decreases because the heat transfer coefficient of gas is normally far lower than that of the solid bed material. This relationship between ‘slugging mode’ and poor heat transfer becomes critical in a FBR when an exothermic gas-solid reaction occurs inside of the reacting zone.

Meanwhile, it is witnessed and reported by many of the prior arts that the direct reaction between HCl and MGSI to produce TCS is extremely exothermic. Most of the prior arts tried to control this exothermic heat but failed.

Therefore, it is naturally concluded that maintaining the ‘reaction bed’ in a ‘bubbling bed’ mode is the first thing to be resolved. However, none of the prior arts disclosed what is the parameter that categories the boundary of ‘bubbling bed.’

### EXPERIMENTS

### Determining “Bubbling Bed” Condition

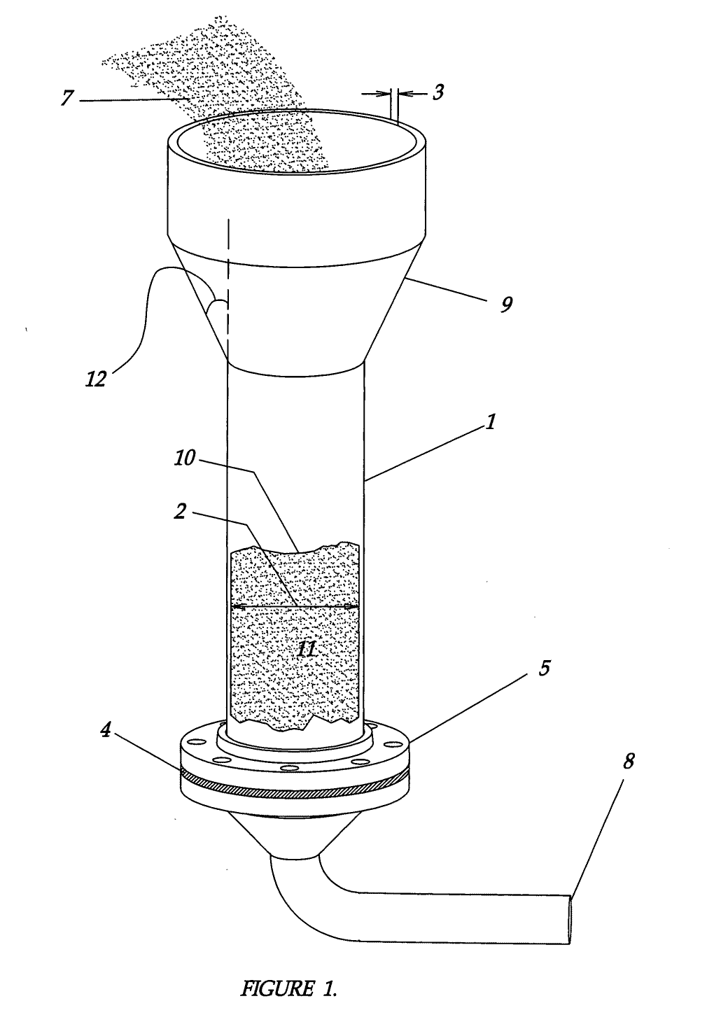

The applicant started to search the ‘bubbling bed’ mode opera ration condition with a transparent ‘cold bed’ of a FBR as shown in the FIG. 1. The lower portion (1) of the cold bed FBR is made of one transparent acrylate pipes of inner-diameter (2), d₁, of 15 cm. Wall thickness (3) of the acrylate pipe is 1 cm to hold the bed weight. Bottom of the lower portion (1) is supported by a gas distributor (4) and fastened via a flange (5) as shown in the FIG. 1. The gas distributor (4) is made of a perforated stainless 304 plate of 1 cm thick. Pluralities of 1 to 2 mm diameter holes (6), for gas entrance, are evenly developed across the whole gas distributor (4) and pluralities of chevron type gas hole caps (4-1) cover the holes (6). Inside of the lower portion (1) of the cold bed FBR is filled with dry sands or glass beads (7) of particle diameter range of 150 to 200 micrometer. The sands or glass beads (7) were dried in an oven which is maintained at 400° C. for over night under nitrogen atmosphere (evaporated liquid nitrogen; 99.999%) to drive out the moisture soaked therein. The dried sands or glass beads (7) were cooled to room temperature under the same nitrogen atmosphere. The cold bed FBR was purged with the same nitrogen over night. The cooled sands or glass beads (7) are charged to the lower portion (1) of the cold bed FBR from the above while the FBR is slightly purging with the nitrogen through the gas distributor (4). Bulk density of the dried sand or beads (7) were 0.98 to 1.02.

Height of the sand bed was varied as shown in the table 1. Nitrogen gas (8) vaporized from a 200 liter liquid nitrogen container was compressed and used as the fluidizing medium. Specific gas velocity of the nitrogen in the lower portion (1) of the FBR was varied from 10 cm/sec to 30 cm/sec. The applicant found from his long experience of FBR operation that relative value of the ‘height of the fluidized bed of the solid particles’ and ‘internal diameter of the fluidizing vessel’ is the key parameter that categorize the boundary of ‘bubbling bed’ and ‘slugging bed.’ However, the ‘height of the fluidized bed of the solid particle’ varies depends on the SGV. So, ‘initial bed height of the charged solid particles’ is selected as one parameter. Here, the initial bed height is the bed height when the bed material is poured from the top freely and piled.

TABLE 1

| | | |
|---|---|---|
| H/d₁* | SGV** | |
| (initial) | (Cm/sec) | Slugging*** |

| | | |
|---|---|---|
| 1 | 10 | No |
| | 20 | No |
| | 30 | No |
| 2 | 10 | No |
| | 20 | No |
| | 30 | No |
| 3 | 10 | Yes, Slight |
| | 20 | Yes, moderate |
| | 30 | Yes, |
| 4 | 10 | Yes |
| | 20 | Yes, bed unstable |
| | 30 | Yes, particles blow out |
| 5 | 10 | Yes, particles blow out |
| | 20 | Yes, particles blow out |
| | 30 | Yes, particles blow out |
| 6 | 10 | Yes, becomes entrained |
| | 20 | Yes, entrained |
| | 30 | Yes, severe entrain |

*H is the height of the sand bed charged initially, d₁ is the inner diameter of the Lower portion of the FBR.
**SGV is the specific gas velocity of nitrogen in through the sand or glass bead bed.
***Slugging is a phenomenon that the fluidizing bed is separated in two zones.

As shown in the table 1, the ‘slugging’ does not occur within the SGV range lower than 30 cm/sec until the ‘initial bed height of the charged solid particles’ (H)/‘inner diameter of the fluidizing vessel’ (d₁) reaches over 2. At the level of H/dᵢ=2, the ‘height of the fluidized bed of the solid particles’ reaches four times of the vessel's inner diameter, d₁, when SGV is 30 cm/sec.

When H/dᵢ is higher than 3, slugging starts even at SGV of 10 cm/sec. At this moment, the ‘height of the fluidized bed’ of the solid particles reached around six times of the inner diameter of the fluidizing vessel. Upper section of the ‘fluidized bed of the solid particles’ is separated from the rest of the bed and is raised higher followed by collapse of the separated portion.

As the H/d₁ is higher than 4, ‘slugging’ accompanied with ‘entrainment’. So, the solid particles carried out of the FBR by the carrier gas.

The other founding is that, when the expending section (9) is too broad, particles that leave the top surface (10) of the fluidized bed (11) accumulate on the inner surface of the expanding section (9). By trial and error, it was found that the angle (12) of the slope of the expanding section (9) from a vertical line should be smaller than 7 degree.

### FBR Design

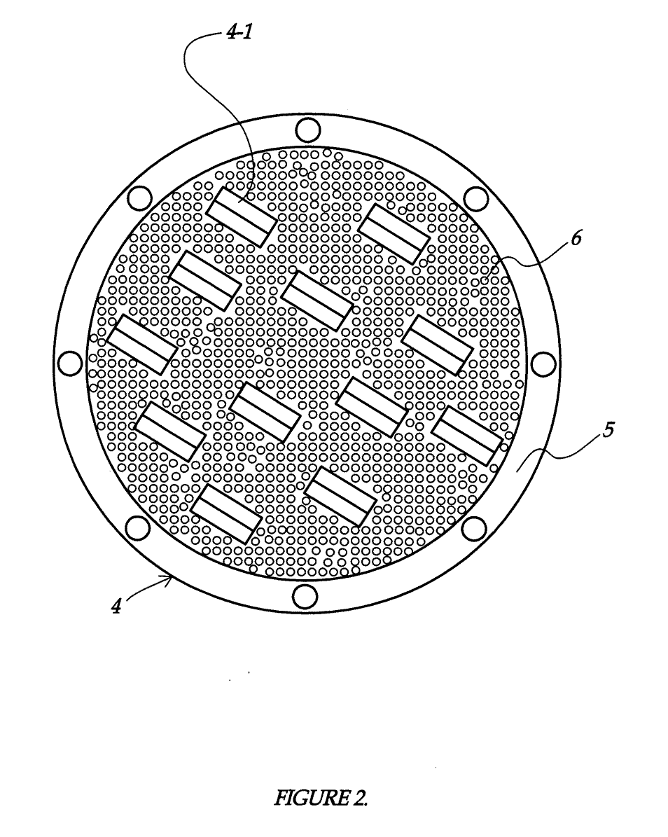

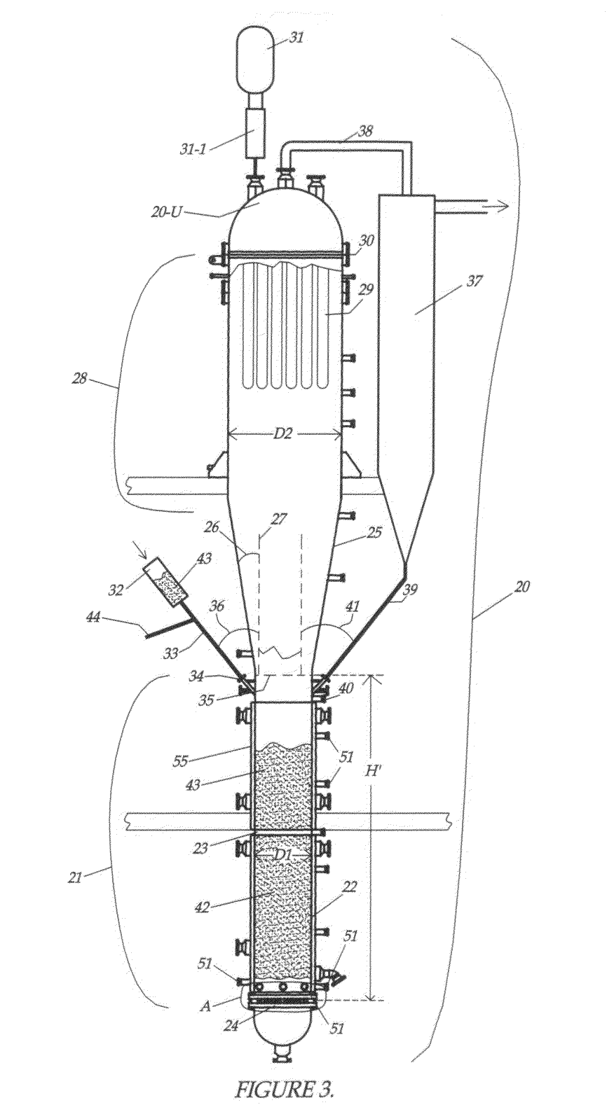

Based on the above findings, the FBR (fluidized bed reactor) (20) for TCS production according to current application is designed as shown in the FIG. 3. The key features of the FBR (20) according to current application are as follows;
In the lower reactor section (21) of the FBR (20), the ratio of the height of the straight zone (H′) over internal diameter (D₁) is fixed between one to eleven.
Cooling jacket (22) surrounds the outer surface (23) of the lower reactor section (21).
A gas distribution plate (24), which has pluralities of small holes (6) and chevron type hole caps (4-1) as shown in the FIG. 2, is installed at the bottom of the lower reactor section (21).
An expanding zone (25) maintains an angle (26) from a vertical line (27), which is extended from the wall of the lower reactor section, smaller than 7 degree and expands until the inner diameter (D₂) of the upper reactor section (28) reaches over two times of the inner diameter (D₁) of the lower reactor section (21).
An internal cooler (29) may be installed inside of the upper reactor section (28) via a flange (30) for easy replacement of cooler (29). However, the lower end of the internal cooler (29) locates at least 6 m above the upper surface of the fluidizing bed to avoid severe erosion.
In another embodiment, there is no internal cooler.
An initial charging material hopper (31) is installed at the top of the upper reactor section to dump in the seed bed material at the start up of the FBR (20). A powder feeder-1, named as initial charging material feeder, (31-1), installed between the initial charging material hopper (31) and the top dome section (20-U), introduces the initial charging material to the FBR (20) to maintain the content of the initial charging material bed in the fluidizing bed (20-1). The initial charging material feeder (31-1) shows ±5% accuracy of feeding the initial charging material within the pressure range up to 10 bar and within the feeding rate range of 1 kg/hr to 10,000 Kg/hr.
The initial charging material is chosen from solid material, except iron compounds, that does not react with any kind of chemicals which supposed to be generated during the hydro chlorination of silicon at reaction temperature up to 600° C. and reaction pressure of 30 bar.
Another powder feeder, MGSI feeder (32), is connected to the FBR (20) via a feeding line (33) that reaches a point (34) just below the upper end (35) of the lower reactor section (21) with an angle (36) from a vertical line (27), which is extended from the wall of the lower reactor section (21), smaller than 20 degrees. MGSI (43) is fed to the FBR (20) via the MGSI feeder (32). The MGSI feeder (32) may be the same type as the powder feeder-1 (31-1).
A cyclone (37) is connected to the FBR (20) via an exit gas line (38) from the top of the FBR (20) and via a recycling line (39) that reaches a point (40), just below the upper end (35) of the lower reactor section (21), with an angle (41) from a vertical line (27) smaller than 20 degrees.
Pluralities of thermocouples (51), 2 to 36, are installed along the brim of the gas distribution plate (24), and 2 to 36 thermocouples are installed along the height of the FBR (20). The temperature reading tells real-time information inside of the FBR (20).

### Hydro Chlorination

For producing TCS rich chlorosilane mixture by direct hydro chlorination of metallurgical silicon, the FBR (20), shown in the FIG. 3, is operated as follows;

The FBR (20) is purged with vaporized liquid nitrogen properly before start up. The reactor is filled with proper initial charging materials (42), including but not limited to, non-porous silica powder or porous silica powder, such as Grace Davison 952, quartz powder, glass beads, zirconium powder, sand, diamond powder, ruby powder, gold powder, silver powder, sapphire powder, garnet powder, opal powder, any kind of gemstone powder, and powder of salt of metal, including but not limited to oxide and halides of metals, except iron compound. Those materials should have elemental SiO₂ contents at least 0.1 wt %. Particle size, true density, and bulk density of the initial charging material is equivalent to that of the metallurgical silicon as shown in the Table 2.

TABLE 2
Properties

| | |
|---|---|
| Particle size (micro meter) | 100~150 |
| Bulk Density (g/cc) | 0.98~1.02 |
| True Density (g/cc) | 1.98~2.01 |
| SiO₂ content (wt %) | >0.1 |

Maximum amount of the initial charging material (42) introduced at the start up is the amount that can fill the height (H) of the lower reactor section (21) of the FBR (20) with the dimension that is equivalent to one to three times of the internal diameter (D₁) of the lower reactor section. The initial charging material (42) bed is fluidized with vaporized liquid nitrogen introduced to the FBR (20) from the bottom through the gas distribution plate (24) at 100° C. in a bubbling bed mode until the effluent gas contains moisture less than 0.1 ppm. Then, the initial charging material bed temperature is increased up to 300° C. by the oil jacket (22) which covers outer layer of lower portion (21) of the FBR (20). After stay at least 30 minutes at 300° C., the nitrogen is switched to hydrogen chloride gradually while maintaining SGV, bed temperature and pressure at 5 bar. Metallurgical grade silicon particles (43) are introduced to the FBR (20) upon the initial charging material (42) bed through a silicon feeding line (33), which reaches a point (34) just below the upper end (35) of the lower reactor section (21) with an angle (36) from a vertical line (27), which is extended from the wall of the lower reactor section, smaller than 20 degrees. The silicon feeding line (33) is connected to an outer carrier gas feeding line (44). Hydrogen chloride at room temperature is introduced through the carrier gas feeding line (44) and disperses and carries the silicon particles (43) into the FBR (20) to produce TCS. For the TCS (Trichlorosilane) production, the cold hydrogen chloride gas removes heat generated by the reaction of silicon with hydrogen chloride. It will reduce burden of the internal cooler (29) if there is one. Major portion of HCl is heated up to 100° C. and introduced to the FBR (20) from the bottom of the FBR through the gas distribution plate (24). Nitrogen and/or hydrogen can be used with or without the initial charging material to depress the exothermic reaction. But, the overall efficiency of the FBR for TCS synthesis is lowered.

As disclosed in many prior arts, they start up the TCS production by directly contacting hydrogen chloride with silicon bed piled in the reactor. Usually 10 to 11 times of the inner diameter of 2 to 5 cm and then gas velocity of 5 to 6 cm/sec. At this velocity, the silicon bed is almost a fixed bed. So, the concentration of HCl along the height of the bed drastically decreased because of the fast reaction between HCl and the silicon particle. Then, lot of the silicon particles, which locate away from the gas distributor, reacts with mixture of HCl and other chlorosilanes which are produced from underneath. Therefore, the yield of TCS or desired silicon chlorides must be lower than that from the stoichiometric reaction conditions. In addition to that, every prior art mentioned about severe exothermic reaction at the bottom of the TCS synthesis reactor when they start up the silicon only piled reactor. It is not only hard to control the initial exotherm but also dangerous for safe operation. Especially when the reactor is big, the initial temperature shooting may result disaster.

To avoid such dangerous initial exotherm, the applicant developed three methods as follows;

First method is to use initial charging material to dilute and disperse the exothermal heat of reaction uniformly throughout the entire reaction bed, not reactor. The initial charging material is chemically inert and at the same time physically stable at the reaction environment. And the physical properties are same as those of the silicon granule used as reactant. Nitrogen and/or hydrogen can be used with or without the initial charging material to depress the exothermic reaction. But, the overall efficiency of the FBR for TCS synthesis is lowered.

The second method is to use a feeder that feeds silicon granules continuously with accuracy of ±5% up to 150 Pisa. It is well known in this industry that on-off valve or some ball valves are used in commercial TCS/STC synthesis process. On-off valves provide pulse feeding and ball valves are easily worn out by the silicon granules. So, both valves provide unstable feeding. When the heat of the reaction is not severe, it may be commercially useful. But, in case of TCS synthesis the heat of reaction is extremely severe. Therefore, pulse or unstable feeding of the silicon granules result in ramping of the reactor temperature and loose of control. It is clear that the reaction condition becomes unstable and the products composition distribution also unstable according to the unstable temperature control.

By combining the above two methods, the applicant can introduce the metallurgical silicon and HCl in to the reactor at a mole ratio of 1:3 to realize a stoichiometrical reaction condition in a FBR's reaction bed. Since the initial charging material (42) is inert to the reaction, this technique can avoid large amount of heat generated at the initial state of the reaction when the bed is filled with one of the reactant, silicon.

The role of the initial charging material (42) is not limited to the dilution of the heat generated. The metallurgical silicon available from the market has large amount of fine particles of micron order. Those submicron particles usually blown up ward and stick to the cold surface of the internal cooler to reduce the heat transfer coefficient of the cooler. In addition to this, those fine particles are carried over to the next process and cause lot of erosion problems. If use porous material, the pores will capture such fine particles inside of the structural pores and makes them react to produce gaseous products to the last moment.

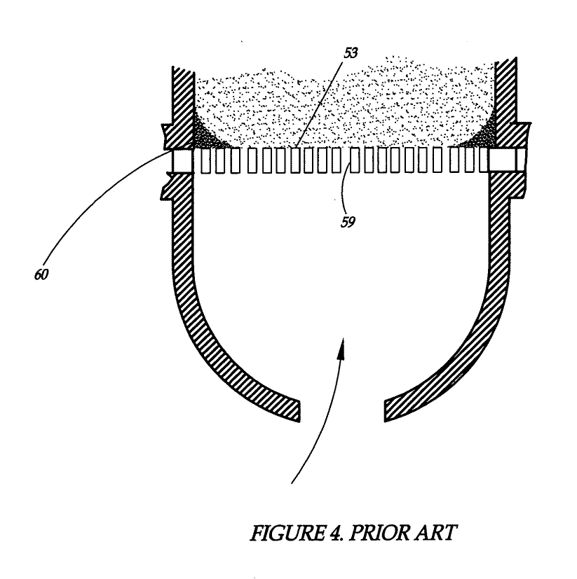

The third method is the gas distribution plate design. FIG. 4 is a prior art that shows the cross-sectional view of a bottom section of a prior art. Usually the gas distributor (53) is a flat panel with pluralities of gas holes (59). This kind of grid type gas distribution plate is widely used for FBR which is operated at high SGV well over 10 cm/sec. However, due to the structure, a stationary zone (60) is easily developed at the corner of the distributor (53) and the bottom of the bed. And materials do not move in this stationary zone (60). Then, heat generated by the reaction can not be effectively removed by the gas and as a result a ‘hot spot’ is formed. At this ‘hot spot’ the reaction produces non-desirable result, such as high molecular weight siloxane and viscous particles aggregated together. Then the bubbling fluidized bed is collapsed and the efficiency of the bed is decreased.

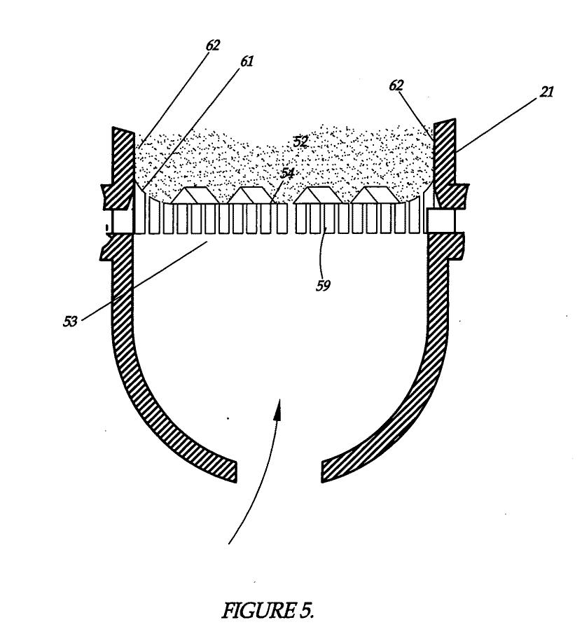

FIG. 5 is a cross sectional view of the new gas distributor (53′) designed according to current invention. The new gas distributor has a brim that has concavely rounded surface (61). Pluralities of chevron shape gas hole caps (54) are developed on the flat upper surface of the new gas distributor (53′). Due to the smoothly rounded inner corner surface (61) between the vertical inner surface (62) of the lower portion (21) of the reactor and the gas distribution plate (53′), the bed (52) circulates naturally along the gas stream. This new gas distributor (53′) will reduce the chance of developing a stationary zone at the bottom of the bed.

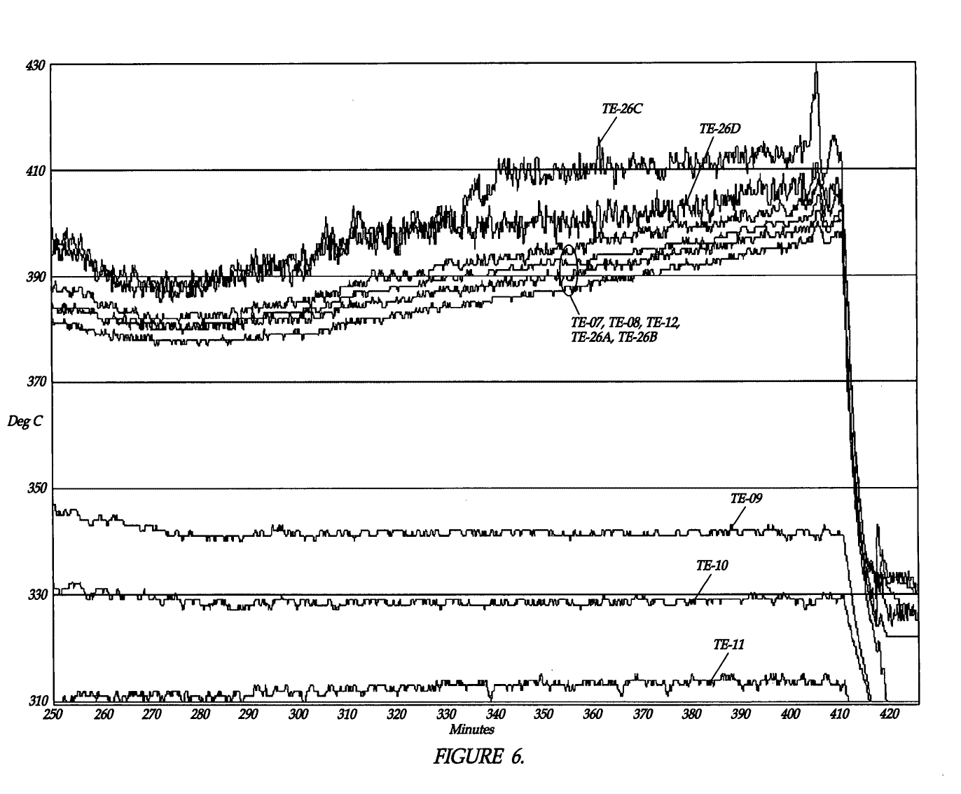

With combination of the above three features, the fluidized bed was enabled to show uniform temperature profile within the fluidized bed (22) as shown in the FIGS. 6 to 9.

Silicon Hydro Chlorination without Initial Charging Material

To compare the effect of the initial charging material, hydro-chlorination of pure silicon, was educed with the same reactor as shown in the FIG. 3. The inner diameter of the lower section (21) of the FBR (20) is 15 cm. MGSI (metallurgical grade silicon; purity 99.8%) is initially charged to the lower portion (21) of the FBR (20) via the MGSI feeder (32). Height of the MGSI initially charged is 30 cm from the gas distribution plate (24). Reactor temperature was controlled by an oil jacket (22) that surrounds the lower portion (21) of the FBR (20).

FIG. 6 is the temperature profile inside of the fluidized bed (52) as the hydro-chlorination proceeds. TE-07, TE-08, TE-09, TE-10, TE-11, and TE-12 are the readings from the thermocouples (51) that locate along the height of the FBR. TE-26-A, TE-26B, TE-26C and TE-26D are the readings from the thermocouples (51) located along the brim of the gas distribution plate (24). The target temperature is 350 C. TE-09 is the reading from the thermocouple that locates at the top of the lower portion (21) of the FBR, up to where the oil jacket (22) is extended. Therefore, TE-09 reading shows the target reaction temperature.

However, as soon as nitrogen is switched to HCl while maintaining the SGV as 25 cm/sec, the temperature of the bed was not controllable. All the temperature around the gas distribution plate (24) (TE-26 A, TE-26B, TE-26C, and TE-26D) and bed temperature (TE-07 and TE-08) jump up to over 390° C. and steadily increase and shows some high peak.

So, we cut the HCl flow to protect the FBR (20). Nitrogen was introduced at SGV of 25 cm/sec to keep the bed fluidized. No MGSI was added to the initially charged amount, we had no chance to add MGSI because of the sharp temperature increase.

FIG. 6 shows that the temperature at the bottom of the bed, TE-26A to TE-26D is highest and the temperature decrease as the distance from the bottom increases. This phenomenon, hottest bottom, is the same as described in the U.S. Pat. Nos. 3,148,035 and 4,044,109.

Moreover, the temperature inside of the fluidizing bed of MGSI is very non-uniform. There is about 30° C. difference between one corner of the bottom and upper surface of the bed (TE-26C and TE-08).

According to the above two prior art, major product from the FBR (20) at this condition is silicon tetrachloride (STC).

### Silicon Hydro Chlorination in the Presence of Initial Charging Material

Effect of the seed bed on the temperature control is investigated with the same FBR (20).

The initial charging material (42), including but not limited to, non-porous silica or porous silica, such as Grace Davison 952, quartz powder, glass beads, zirconium powder, sand, diamond, lobby sapphire, garnet, opal, any kind of gemstone, any kind of metal salt except iron compound, is initially charged to the lower portion (21) of the FBR (20) via the initial charging material feeder (31-1). The height of the initially charged material bed is controlled to reach 30 cm. Target bed temperature is set 350° C., the same as the previous test-silicon hydro chlorination.

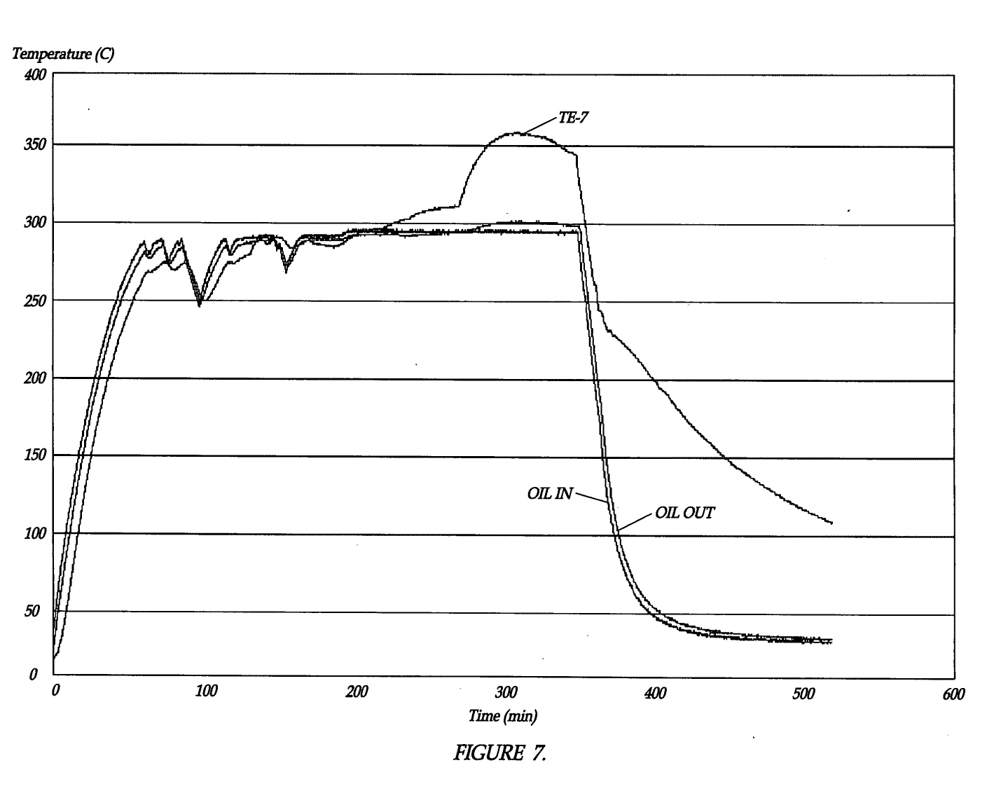

FIG. 7 shows the temperature profile of the TE-7, the thermocouple reading from the middle of the bed height, 20 cm above the gas distribution plate (24), and jacket oil temperature from the start up.

About 4 hours after start up, the temperature reached at 300° C. Nitrogen is switched to HCl while maintaining SGV as 25 cm/sec and reactor pressure at 5 bar. After 10 min, MGSI was introduced to the FBR (20) at a rate of 20 g/min. The TE-7 reading, bed temperature, increases slowly. About 50 minutes later, TE-7 reading jumped up. It seems that there is some induction period. (Some prior art described this period as the time needed for oxygen molecules, which was adsorbed on the fresh silicon surface, is replaced by HCl.)

So, we reduced the feeding rate of MGSI down to 15 g/min. However, the steep increase of TE-7 reading last about 10 minutes. After that the TE-7 reading's increasing speed is reduced. The MGSI feeding rate was maintained as 15 g/min for one more hour and cut the MGSI and switches HCl to nitrogen and cools the reactor.

Between 320 min to 420 min lap time, the oil out temperature from the jacket is higher than the oil in temperature to the jacket and TE-7 reading stayed around 350° C.

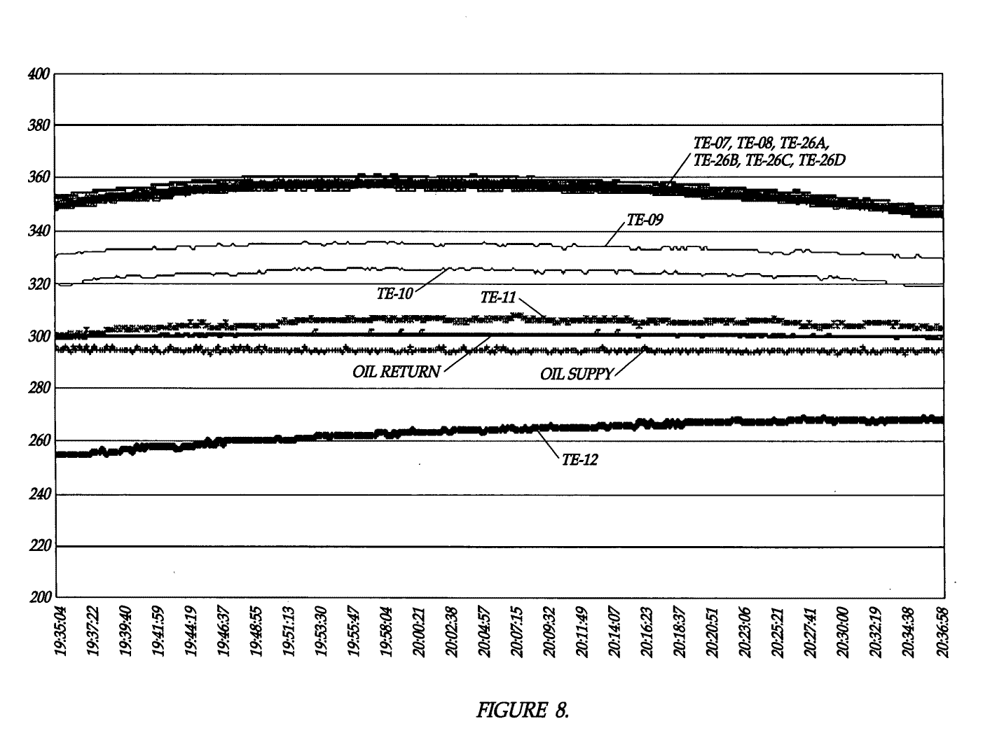

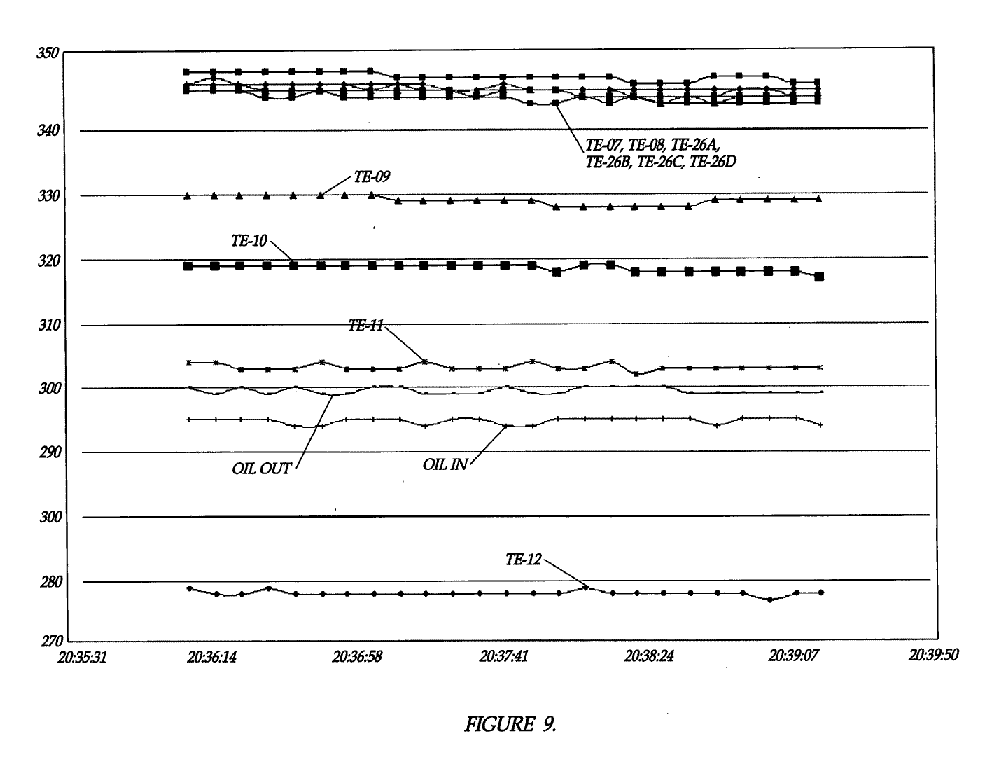

FIG. 8 and FIG. 9 show the temperature readings in different part of the FBR (20) while the reaction temperature was in control.

As shown in FIG. 8 for the one hour, the reactor temperature was controlled around 350° C. During that period, all the temperature readings inside of the bed (TE-26 A, TE-26B, TE-26C, TE-26D; all indicate temperature just above gas distribution plate (24) TE-07, TE-08 middle and top of the fluidizing bed) fall on almost one straight line and overlapped each other. FIG. 9 shows more detailed clear picture of how they overlapped each other. There is almost no temperature deviation inside of the fluidizing bed.

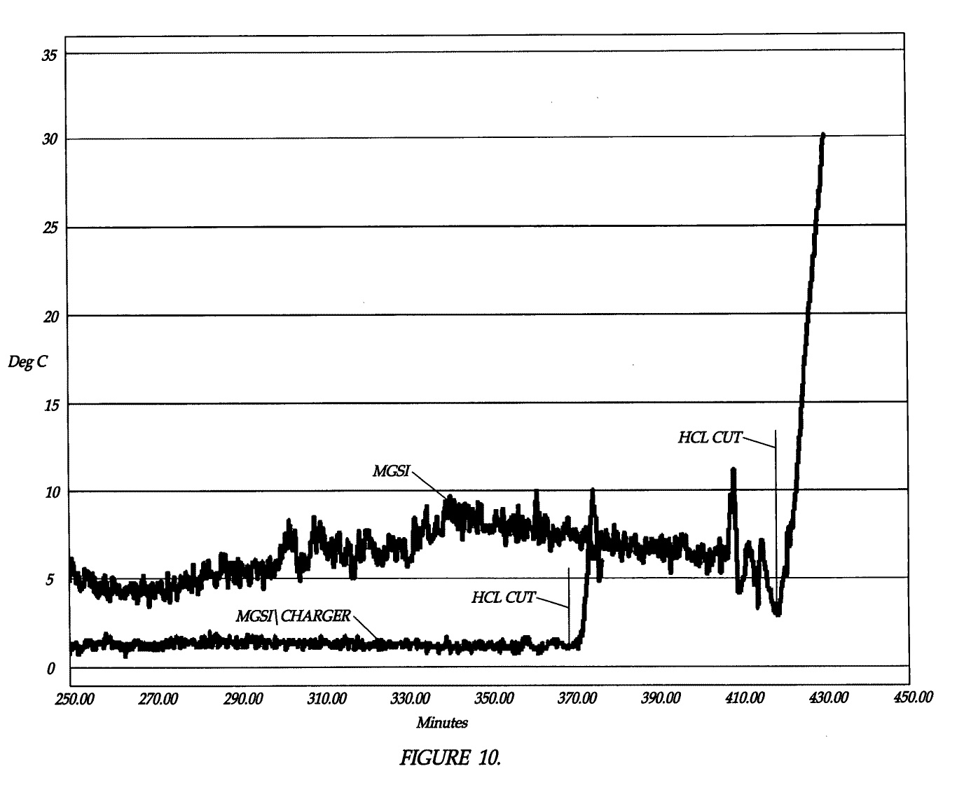

FIG. 10 shows the temperature deviation within the reacting fluidized bed in both case of the hydro chlorination with—and without—the initially charging material.

The deviation was calculated as follows;

Deviation=Σᵢ(T₁−Tₐᵥ)/6 i=1 to 6

Tₐᵥ=(TE-26A+TE-26B+TE-26C+TE-26D+TE-07+TE-08)/6

The direct hydro chlorination of MGSI without—the initially charging material shows about 5 to 10 degree C. deviation from the average reactor temperature and the deviation changed with time. In other worlds, it is unstable and hard to control the reaction temperature uniformly within the bed.

Meanwhile, the reaction in the presence of the seed bed shows only ±1 or 2 degree centigrade standard deviation around 350° C. It means that the deviation is less than 1% of the reaction temperature throughout the entire reaction fluidized bed. It falls almost within the error range. ±5 degree Centigrade deviation is allowable.

This show that the reactor system of the current invention and the three features combined enabled to control the exothermic reaction of direct chlorination of MGSI.

That uniform temperature profile at the temperature range means production of TCS rich silane mixture gas more stably and continuously.

What is claimed is:

1. A method of producing TCS rich silane gas mixture stably from a fluidized bed reactor, which is comprised of;
a lower reactor section of the fluidized bed, in which the ratio of the height of the straight zone (H′) over internal diameter (D₁) is fixed as six,
and
a cooling jacket surrounding the outer surface of the lower reactor section,
and
a gas distribution plate, whose brim is rounded concavely to form a smooth round inner surface between the vertical inner surface of the lower reactor section and the gas distribution plate which is installed at the bottom of the lower reactor section and which is equipped with pluralities of gas holes of diameter 2 mm and pluralities of chevron shape gas hole caps that cover the holes,
and
an upper reactor section,
and
an expanding zone locates between the lower reactor section and the upper reactor section
and
maintains an angle from a vertical line of 7 degree and expands until the inner diameter (D₂) of the upper reactor section reaches two times of the inner diameter (D₁) of the lower reactor section,
and
an internal cooler that is installed inside of the upper reactor section via a flange for easy replacement,
and
an initially charging material hopper that is installed at the top of the upper reactor section to dump in the seed bed material at the start up of the fluidized bed reactor,
and
an MGSI feeder that controls feeding rate of the silicon at a range of 100 Kg/hr with +5% deviation at a pressure of 150 Pisa and is connected to the fluidized bed reactor via a feeding line that reaches a point just below the upper end of the lower reactor section with an angle from a vertical line smaller than 20 degrees,
and
an initial charging material feeder that controls feeding rate of the initial charging material at a range of 100 Kg/hr with +5% deviation at a pressure of 150 Pisa and is connected to the fluidized bed reactor,
and
a cyclone that is connected to the fluidized bed reactor via an exit gas line from the top of the fluidized bed reactor and via a recycling line that reaches a point just below the upper end of the lower reactor section with an angle from a vertical line smaller than 20 degrees,
and
pluralities of thermocouples; four of them are installed along the brim of the gas distribution plate and twelve of them are installed along the height of the FBR to get real-time temperature information inside of the FBR.

2. A method of producing TCS rich silane gas mixture stably from a fluidized bed reactor, which is comprised of;
a lower reactor section of the fluidized bed, in which the ratio of the height of the straight zone (H′) over internal diameter (D₁) is fixed as six,
and
a cooling jacket surrounding the outer surface of the lower reactor section,
and
a gas distribution plate, whose brim is rounded concavely to form a smooth round inner surface between the vertical inner surface of the lower reactor section and the gas distribution plate which is installed at the bottom of the lower reactor section and which is equipped with pluralities of gas holes of diameter 2 mm and pluralities of chevron shape gas hole caps that cover the holes,
and
an upper reactor section,
and
an expanding zone locates between the lower reactor section and the upper reactor section
and
maintains an angle from a vertical line of 7 degree and expands until the inner diameter (D₂) of the upper reactor section reaches two times of the inner diameter (D₁) of the lower reactor section,
and
an initially charging material hopper that is installed at the top of the upper reactor section to dump in the seed bed material at the start up of the fluidized bed reactor,
and
an MGSI feeder that controls feeding rate of the silicon at a range of 100 Kg/hr with +5% deviation at a pressure of 150 Pisa and is connected to the fluidized bed reactor via a feeding line that reaches a point just below the upper end of the lower reactor section with an angle from a vertical line smaller than 20 degrees,
and
an initial charging material feeder that controls feeding rate of the initial charging material at a range of 100 Kg/hr with +5% deviation at a pressure of 150 Pisa and is connected to the fluidized bed reactor,
and
a cyclone that is connected to the fluidized bed reactor via an exit gas line from the top of the fluidized bed reactor and via a recycling line that reaches a point just below the upper end of the lower reactor section with an angle from a vertical line smaller than 20 degrees,
and
pluralities of thermocouples; four of them are installed along the brim of the gas distribution plate and twelve of them are installed along the height of the FBR to get real-time temperature information inside of the FBR.

3. A method of producing TCS rich silane gas mixture stably with the fluidized bed reactor of the claim 1 and 2, wherein the ratio of the height of the straight zone (H′) over internal diameter (D₁) is fixed as six.

4. A method of producing TCS rich silane gas mixture stably with the fluidized bed reactor of the claim 1 and 2, wherein the ratio of the height of the straight zone (H′) over internal diameter (D₁) is fixed as five.

5. A method of producing TCS rich silane gas mixture stably with the fluidized bed reactor of the claim 1 and 2, wherein the ratio of the height of the straight zone (H′) over internal diameter (D₁) is fixed as four.

6. A method of producing TCS rich silane gas mixture stably with the fluidized bed reactor of the claim 1 and 2, wherein the ratio of the height of the straight zone (H′) over internal diameter (D₁) is fixed as two.

7. A method of producing TCS rich silane gas mixture stably with the fluidized bed reactor of the claim 1 and 2, wherein the ratio of the height of the straight zone (H′) over internal diameter (D₁) is fixed as one.

8. A method of producing TCS rich silane gas mixture stably with the fluidized bed reactor of the claim 1 and 2, wherein the amount of the initial charging material introduced at the start up is the amount that can fill the height (H) of the lower reactor section with a dimension that is equivalent to the internal diameter (D₁) of the lower reactor section.

9. A method of producing TCS rich silane gas mixture stably with the fluidized bed reactor of the claim 1 and 2, wherein the amount of the initial charging material introduced at the start up is the amount that can fill the height (H) of the lower reactor section with a dimension that is two times of the internal diameter (D₁) of the lower reactor section.

10. A method of producing TCS rich silane gas mixture stably with the fluidized bed reactor of the claim 1 and 2, wherein the amount of the initial charging material introduced at the start up is the amount that can fill the height (H) of the lower reactor section with a dimension that is three times of the internal diameter (D₁)) of the lower reactor section.

11. A method of producing TCS rich silane gas mixture stably with the fluidized bed reactor of the claim 1 and 2, wherein the amount of the initial charging material introduced at the start up is the amount that can fill the height (H) of the lower reactor section with a dimension that is four times of the internal diameter (D₁) of the lower reactor section.

12. A method of producing TCS rich silane gas mixture stably with the fluidized bed reactor of the claim 1 and 2, wherein part of HCl is introduced to the fluidized bed reactor at room temperature through the carrier gas feeding line.

13. A method of producing TCS rich silane gas mixture stably with the fluidized bed reactor of the claim 1 and 2, wherein the end of the silicon feeding line is embedded just under the upper surface of the initially charging material bed with an angle from a vertical line, which is extended from the wall of the lower reactor section, of 20 degree.

14. A method of producing TCS rich silane gas mixture stably with the fluidized bed reactor of the claim 1 and 2, wherein a recycling line from the cyclone reaches a point, just below the upper end of the lower reactor section, with an angle from a vertical line of 20 degrees.

15. A method of producing TCS rich silane gas mixture stably from the fluidized bed reactor of the claims 1 and 2, use a chemically inert and physically stable initial charging material to dilute and disperse the exothermic heat of hydro chlorination of MGSI.

16. A method of producing TCS rich silane gas mixture stably from the fluidized bed reactor of the claims 1 and 2, use a chemically inert and physically stable initial charging material with nitrogen to dilute and disperse the exothermic heat of hydro chlorination of MGSI.

17. A method of producing TCS rich silane gas mixture stably from the fluidized bed reactor of the claims 1 and 2, use a chemically inert and physically stable initial charging material with hydrogen to dilute and disperse the exothermic heat of hydro chlorination of MGSI.

18. A method of producing TCS rich silane gas mixture stably from the fluidized bed reactor of the claims 1 and 2, the initial charging material is quartz powder.

19. A method of producing TCS rich silane gas mixture stably from the fluidized bed reactor of the claims 1 and 2, the initial charging material is armorphous quartz powder.

20. A method of producing TCS rich silane gas mixture stably from the fluidized bed reactor of the claims 1 and 2, the initial charging material is sand.

21. A method of producing TCS rich silane gas mixture stably from the fluidized bed reactor of the claims 1 and 2, the initial charging material is non-porous silica powder.

22. A method of producing TCS rich silane gas mixture stably from the fluidized bed reactor of the claims 1 and 2, the initial charging material porous silica powder.

23. A method of producing TCS rich silane gas mixture stably from the fluidized bed reactor of the claims 1 and 2, the initial charging material is glass beads.

24. A method of producing TCS rich silane gas mixture stably from the fluidized bed reactor of the claims 1 and 2, the initial charging material is zirconium powder.

25. A method of producing TCS rich silane gas mixture stably from the fluidized bed reactor of the claims 1 and 2, the number of thermo-couples installed along the brim of the gas distribution plate is two.

26. A method of producing TCS rich silane gas mixture stably from the fluidized bed reactor of the claims 1 and 2, the number of thermo-couples installed along the brim of the gas distribution plate is four.

27. A method of producing TCS rich silane gas mixture stably from the fluidized bed reactor of the claims 1 and 2, the number of thermo-couples installed along the brim of the gas distribution plate is six.

28. A method of producing TCS rich silane gas mixture stably from the fluidized bed reactor of the claims 1 and 2, the number of thermo-couples installed along the brim of the gas distribution plate is twelve.

29. A method of producing TCS rich silane gas mixture stably from the fluidized bed reactor of the claims 1 and 2, the number of thermo-couples installed along the height of the FBR is two.

30. A method of producing TCS rich silane gas mixture stably from the fluidized bed reactor of the claims 1 and 2, the number of thermo-couples installed along the height of the FBR is three.

31. A method of producing TCS rich silane gas mixture stably from the fluidized bed reactor of the claims 1 and 2, the number of thermo-couples installed along the height of the FBR is four.

32. A method of producing TCS rich silane gas mixture stably from the fluidized bed reactor of the claims 1 and 2, the number of thermo-couples installed along the height of the FBR is five.

33. A method of producing TCS rich silane gas mixture stably from the fluidized bed reactor of the claims 1 and 2, the number of thermo-couples installed along the height of the FBR is six.

34. A method of producing TCS rich silane gas mixture stably from the fluidized bed reactor of the claims 1 and 2, the number of thermo-couples installed along the height of the FBR is twelve.

35. A method of producing TCS rich silane gas mixture stably from the fluidized bed reactor of the claims 1 and 2, maintaining standard temperature deviation within ±5 degree C. throughout the fluidizing bed at the reaction condition of 350° C. and 5 bar.

36. A method of producing TCS rich silane gas mixture stably from the fluidized bed reactor of the claims 1 and 2, maintaining standard temperature deviation within ±1 degree C. throughout the fluidizing bed at the reaction condition of 350° C. and 5 bar.
